(19) United States
(12) Patent Application Publication
(10) Pub. No.: US 2018/0211407 A1
(43) Pub. Date: Jul. 26, 2018

(54) SYSTEM AND METHOD FOR DETECTING POSITION DEVIATION OF INVENTORY HOLDER BASED ON FEATURE INFORMATION GRAPHS

(71) Applicant: Zhejiang Guozi Robot Technology Co., Ltd., Hangzhou City, Zhejiang (CN)

(72) Inventors: Hong HUANG, Hangzhou (CN); Yikun TAO, Hangzhou (CN); Xia WANG, Hangzhou (CN); Hongbo ZHENG, Hangzhou (CN); Lingfen ZHU, Hangzhou (CN); Xinfeng DU, Hangzhou (CN); Jizhong SHEN, Hangzhou (CN); Xudong MI, Hangzhou (CN)

(21) Appl. No.: 15/305,555

(22) PCT Filed: Oct. 8, 2016
(86) PCT No.: PCT/CN2016/101512

§ 371 Date: Oct. 20, 2016

(51) Int. Cl. G06T 7/73; B25J 9/16; B65G 1/04; G06K 7/14; G06K 7/10

(52) U.S. Cl. CPC G06T 7/73; B25J 9/1697; B65G 1/04; G06T 2207/30204; G06K 7/10722; Y10S 901/47; G06K 7/1417

(57) ABSTRACT

The present invention provides a system and method for detecting position deviation of inventory holder based on feature information graphs. Step 1. Mount upward-looking cameras on robots; Step 2. Calibrate the mapping relationship between the pixel coordinate system of the cameras and robot coordinate system; Step 3. Dispose graphs having feature information on the bottom of the inventory holders, and measure coordinates of the feature points of the graphs under the coordinate system of inventory holders; Step 4. After the robots lift the inventory holders, the upward-looking cameras scan the graphs, and obtain the pixel coordinates of the feature points of the graphs; Step 5. Via the mapping relationship in Step 2, calculate and find out the coordinates mapped into the robot coordinate system by the pixel coordinates of the feature points of the graphs; Step 6. Calculate the position deviations of the inventory holders relative to the robots. The present invention detects the position deviations of inventory holders by cameras. The entire implementation procedure is convenient and quick, since cameras have low prices, and it is not needed to reconstruct the colossal number of inventory holders, therefore the costs are low.

### FIELD OF THE INVENTION

The present invention relates to detection of inventory holders in warehouses, more particularly, to a system and method for detecting position deviations of inventory holders based on feature information graphs.

### DESCRIPTION OF THE PRIOR ART

As far as materials management systems in modern warehouses, quick, precise automated material sorting is an increasingly definitive and inevitable trend. Mobile robots are a significant integral part in the automated materials sorting systems, which achieve automated dispatching and transportation by lifting inventory holders, transporting inventory holders, dropping inventory holders according to the preset flows. However, during the whole process of transporting inventory holders by robots, because there exist deviations in lifting and laying down and in the motions of robots, resulting in the positions of inventory holders deviate from the preset positions thereof gradually, when the extents of the deviations exceed a certain threshold, the robots would not transport inventory holders normally, which would result in the failure of the entire automated sorting systems.

The techniques for avoiding exaggeration of deviation of inventory holders in the prior art, on the one hand, are by means of controlling the motion of robots accurately, on the other hand, are by means of disposing matched position-limit devices in the lifting mechanisms and inventory holders to restrict the deviation of inventory holders from the preset positions. Position-limit devices enable position deviation of inventory holders and robots not to diverge, and precise robot motion controls enable deviation of robots from the preset positions not to diverge, thus enable inventory holders to stabilize within the acceptable deviation range of the preset positions. But it is needed to design and process position-limit devices, of which the processing cycle is long, the costs are high, and it is needed to reconstruct the inventory holders in order to mount the position-limit devices, the universality of inventory holders is an enormous problem, and the tolerant deviations of position-limit devices are limited, there exist situations that too large deviations result in position-limit devices losing efficacy.

In the automated materials sorting in the warehouses, it is needed to detect the position deviations of inventory holders. For a warehouse, the arrangement, sorting, storage and distribution of materials are very important and complicated matters, especially for large-scale warehouses, when the kinds and quantities of materials are large to a certain extent, it is extremely difficult to guarantee the matters to be performed normally and orderly. The conventional manual sorting cannot be adapted to the management of modernized warehouses increasingly; it gives place to automated sorting established on the basis of informatization and industrialization. For the management of materials in modern warehouses, transformation from manual manner to semi-manual semi-automation manner or even full automation manner is already an irreversible trend. Automated sorting systems for materials in warehouses generally comprise maintenances and managements of materials data, dispatching transportation of mobile robots, motions of mobile robots and execution control thereof, it can be seen that mobile robots play a very important role in the whole system.

The general workflows of mobile robots are as follows: accept dispatch instruction, move to specified position, lift inventory holders, move to destination position, and drop inventory holders. During the whole flow, the robots must guarantee the inventory holders to be placed within permissible error range of the preset positions in addition to guarantee themselves to move and stop precisely according to instructions.

However, because the motion and stop of robots have random errors, which will result in variations of parking positions of the inventory holders, after parking many times in a long period, the inventory holders could deviate from the permissible error ranges of the preset positions, thereby, resulting in failures of subsequent transportation.

### SUMMARY OF THE INVENTION

In order to solve the foregoing problems, the present invention provides a method for detecting position deviations of inventory holders based on feature information graphs, wherein the method includes the following steps:

Step 1. Mount upward-looking cameras on robots; let the optical axes of the upward-looking cameras face upward;
Step 2. Calibrate the mapping relationship between the pixel coordinate system of the cameras and robot coordinate system;
Step 3. Dispose graphs having feature information on the bottom of the inventory holders, and measure coordinates of the feature points of the graphs under the coordinate systems of inventory holders;
Step 4. After the robots lift the inventory holders, the upward-looking cameras scan the graphs, and obtain the pixel coordinates of feature points of graphs;
Step 5. Via the mapping relationship in Step 2, calculate and find out the coordinates mapped into the robot coordinate system by the pixel coordinates of the feature points of the graphs;
Step 6. Calculate the position deviations of the inventory holders relative to the robots, according to the coordinates under the coordinate system of inventory holders and the coordinates under the robot coordinate system, of a plurality of the feature points of the graphs.

Furthermore, in Step 2, the mapping relationship refers to homography matrix H of the camera, the mathematical meaning of homography matrix H is:

$$\begin{matrix}[ \begin{matrix}{x}^{′} \\ {y}^{′} \\ {z}^{′}\end{matrix} ] = H * [ \begin{matrix}u \\ v \\ 1\end{matrix} ] & ( Formula 1 ) \\ [ \begin{matrix}x \\ y\end{matrix} ] = [ \begin{matrix}{x}^{′} / {z}^{′} \\ {y}^{′} / {z}^{′}\end{matrix} ] & ( Formula 2 )\end{matrix}$$

wherein, select the plane where the bottom of inventory holders are located after the robots lift the inventory holders as a reference plane,

$$[ \begin{matrix}u \\ v\end{matrix} ]$$

are pixel coordinates on the camera's imaging plane of a certain point on the reference plane,

$$[ \begin{matrix}x \\ y\end{matrix} ]$$

are coordinates under the robot coordinate system of a certain point on the reference plane;

$$[ \begin{matrix}{x}^{′} \\ {y}^{′} \\ {z}^{′}\end{matrix} ]$$

are homogeneous coordinates.

The calibrating method of H is: obtain pixel coordinates on the camera's imaging plane and coordinates under the robot coordinate system of more than four points on the reference plane, then invoke the homography matrix calculation function in the open source visual sense library opencv to get H.

Furthermore, in Step 6, the position deviations of inventory holders relative to robots can be calculated and obtained by the following formula:

$$[ \begin{matrix}1 & 0 & {x}_{h} & - {y}_{h} \\ 0 & 1 & {y}_{h} & {x}_{h}\end{matrix} ] * [ \begin{matrix}{x}_{1} \\ {x}_{2} \\ {x}_{3} \\ {x}_{4}\end{matrix} ] = [ \begin{matrix}{{x}_{r}}_{ } \\ {y}_{r}\end{matrix} ] \qquad ( Formula 5 )$$

Substitute the coordinates under the coordinate system of the inventory holders and the coordinates under the robot coordinate system of a plurality of feature points that are detected into formula 3, calculate x₁, x₂, x₃, x₄ by least square method, then normalize x₃, x₄, find out d θ according to reverse triangle after normalization;

In the formula, x₁=dx, x₂=dy, x₃=cos d θ, x₄=sin d θ,

$$[ \begin{matrix}{x}_{h} \\ {y}_{h}\end{matrix} ]$$

are coordinates under the coordinate system of inventory holders of the feature points,

$$[ \begin{matrix}{x}_{r} \\ {y}_{r}\end{matrix} ]$$

are coordinates under the robot coordinate system of the feature points,

$$[ \begin{matrix}dx \\ dy \\ d θ\end{matrix} ]$$

are position deviations of inventory holders relative to robots.

The present invention also discloses a system for detecting position deviations of inventory holders based on feature information graphs, comprising robots, upward-looking cameras mounted thereon, inventory holders as well as graphs with feature information disposed on the bottom of the inventory holders; the graphs with feature information including two-dimensional codes, with four angular points of the two-dimensional codes serving as feature points of the graphs.

Furthermore, the number of two-dimensional codes is 9.

Furthermore, the bottom of the inventory holders are full of two-dimensional codes.

Furthermore, the bottom of the inventory holders are affixed with arbitrary number of two-dimensional codes.

The advantageous effects of the present invention are as follows:

1. The present invention, by mounting upward-looking cameras on the robots, and affixing graphs with known feature information to the inventory holders, detects the position deviations of inventory holders by cameras. The entire implementation procedure is convenient and quick, since cameras have low prices, and it is not needed to reconstruct the colossal number of inventory holders, therefore the costs are low.
2. It is only needed to affix graphs with feature information to the bottom of the inventory holders, without reconstructing inventory holders, therefore the systems have good universality
3. There is no limit on the number of feature information graphs affixed to the bottom of the inventory holders in the present invention, theoretically, the entire bottom of inventory holders may be affixed with them, cameras only need to scan any number of graphs to calculate position deviations of the inventory holder, therefore, theoretically, as long as the cameras are able to scan the bottom of the inventory holders, the inventory holders can be corrected back to the preset positions

### BRIEF DESCRIPTION OF THE DRAWINGS

FIG. 1 shows two-dimensional code graphs affixed to the bottom of the inventory holders in an embodiment of the present invention.

### DETAILED DESCRIPTION OF THE PREFERRED EMBODIMENTS

The present invention will be explained in greater detail herein in conjunction with the accompanying drawings and specific embodiments.

The present invention discloses a method for detecting position deviations of inventory holders based on feature information graphs, including the following steps:

Step 1. Mount upward-looking cameras on robots; let the optical axes of the upward-looking cameras face upward, thereby, perpendicular to the plane of the bottom of inventory holders;
Step 2. Calibrate the mapping relationship between the pixel coordinate system of the cameras and robot coordinate system;

Wherein, the mapping relationship refers to homography matrix H of the camera, the mathematical meaning thereof is:

$$\begin{matrix}[ \begin{matrix}{x}^{′} \\ {y}^{′} \\ {z}^{′}\end{matrix} ] = H * [ \begin{matrix}u \\ v \\ 1\end{matrix} ] & ( Formula 1 ) \\ [ \begin{matrix}x \\ y\end{matrix} ] = [ \begin{matrix}{x}^{′} / {z}^{′} \\ {y}^{′} / {z}^{′}\end{matrix} ] & ( Formula 2 )\end{matrix}$$

Wherein, select the plane where the bottom of inventory holders are located after the robots lift the inventory holders as a reference plane,

$$[ \begin{matrix}u \\ v\end{matrix} ]$$

are pixel coordinates on the camera's imaging plane of a certain point on the reference plane,

$$[ \begin{matrix}x \\ y\end{matrix} ]$$

are coordinates under the robot coordinate system of a certain point on the reference plane;

$$[ \begin{matrix}{x}^{′} \\ {y}^{′} \\ {z}^{′}\end{matrix} ]$$

are homogeneous coordinates.

The calibrating method of H is: obtain pixel coordinates on the camera's imaging plane and coordinates under the robot coordinate system of more than four points on the reference plane, then invoke the homography matrix calculation function in the open source visual sense library opencv to get H.

Wherein, the calibration process of the homography matrix H is: in non-operating state of the robots, affix graphs having four feature points to the bottom of the inventory holders, after the robots lift the inventory holders, the pixel coordinates of the feature points can be extracted from the graphs in cameras via programs directly, the coordinates of the feature points under robot coordinate system can be manually measured directly. Substitute the measured pixel coordinates and the coordinates under the robot coordinate system of the feature points, into the homography matrix calculation function in the open source visual sense library opencv to get homography matrix H, the calibration is completed.

Step 3. Dispose graphs having feature information on the bottom of the inventory holders, measure coordinates of the feature points of the graphs under the coordinate systems of inventory holders;
Step 4. After the robots lift the inventory holders, the upward-looking cameras scan the graphs, and obtain the pixel coordinates of the feature points of graphs; Place the data of cameras into the programs, the programs perform detections on the graphs in the images according to acquired images in cameras, and the pixel coordinates of the feature points in the graphs are obtained.
Step 5. Via the mapping relationship in Step 2, calculate and find out the coordinates mapped into the robot coordinate system by the pixel coordinates of feature points of the graphs;
Step 6. Calculate the position deviations of the inventory holders relative to the robots, according to the coordinates under the coordinate system of inventory holders and the coordinates under the robot coordinate system, of a plurality of the feature points of the graphs. Wherein, the position deviations of inventory holders relative to robots can be calculated and obtained by the following formula: position in the present invention refers to location and orientation, because of the two-dimensional space, concretely, it refers to x, y coordinates and orientation angle (the orientation of the inventory holders).

As regard to a certain feature point in the two-dimensional space measured according to the above steps, its coordinates under the robot coordinate system are

$$[ \begin{matrix}{x}_{r} \\ {y}_{r}\end{matrix} ] ,$$

its coordinates under the coordinate system of inventory holders are

$$[ \begin{matrix}{x}_{h} \\ {y}_{h}\end{matrix} ] ,$$

the position of the coordinate system of inventory holders under the robot coordinate system are expressed as

$$[ \begin{matrix}dx \\ dy \\ d θ\end{matrix} ] ,$$

namely, the position deviations of inventory holders relative to robots. By Euclidean space coordinate transformation (formula 3), we get

$$[ \begin{matrix}{x}_{r} \\ {y}_{r}\end{matrix} ] = [ \begin{matrix}d x \\ d y\end{matrix} ] + [ \begin{matrix}cos d θ & - sin d θ \\ sin d θ & cos d θ\end{matrix} ] * [ \begin{matrix}{x}_{h} \\ {y}_{h}\end{matrix} ] \qquad ( Formula 3 )$$

The above formula can be expressed as

$$[ \begin{matrix}1 & 0 & {x}_{h} & - {y}_{h} \\ 0 & 1 & {y}_{h} & {x}_{h}\end{matrix} ] * [ \begin{matrix}dx \\ dy \\ cos d θ \\ sin d θ\end{matrix} ] = [ \begin{matrix}{x}_{r} \\ {y}_{r}\end{matrix} ] \qquad ( Formula 4 )$$

Let x₁=dx, x₂=dy, x₃=cos d θ, x₄=sin d θ, then

$$[ \begin{matrix}1 & 0 & {x}_{h} & - {y}_{h} \\ 0 & 1 & {y}_{h} & {x}_{h}\end{matrix} ] * [ \begin{matrix}{x}_{1} \\ {x}_{2} \\ {x}_{3} \\ {x}_{4}\end{matrix} ] = [ \begin{matrix}{x}_{r} \\ {y}_{r}\end{matrix} ] \qquad ( Formula 5 )$$

Substitute the coordinates under the coordinate system of the inventory holders and the coordinates under the robot coordinate system of a plurality of feature points that are detected into formula 5, calculate x₁, x₂, x₃, x₄ by linear least square method, thus the values of dx, dy, sin d θ and cos d θ are obtained.

After calculation, since x₃²+x₄²=cos² d+sin² dθ=1, perform normalization to x₃, x₄, the normalization equations are as follows:

x₃=x₃/\sqrt{x₃²+x₄²} (Formula 6)

x₄=x₄/\sqrt{x₃²+x₄²} (Formula 7)

Calculate d θ according to reverse triangle after normalization.

Thus,

$$[ \begin{matrix}dx \\ dy \\ d θ\end{matrix} ]$$

is obtained, that is, the position deviations of inventory holders relative to robots are obtained.

The robots are able to estimate the positions of themselves in real time, when they detect the positions of inventory holders relative to themselves, robots are able to work out the accurate positions of inventory holders in the map of the warehouse, and are able to place inventory holders to the preset positions by adjusting the positions of themselves.

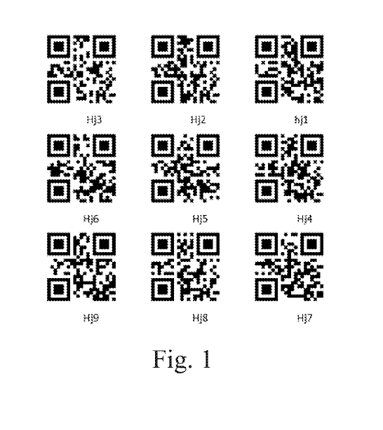

The present invention also discloses a system for detecting position deviations of inventory holders based on feature information graphs, comprising robots, upward-looking cameras mounted thereon, inventory holders as well as graphs with feature information disposed on the bottom of the inventory holders. As shown in FIG. 1, in an embodiment, the graphs with feature information include two-dimensional codes, with four angular points of the two-dimensional codes serving as feature points of the graphs. In an embodiment, the number of two-dimensional codes is 9, the 9 two-dimensional codes are distributed by a certain rule, theoretically, cameras only need to scan one two-dimensional code to calculate the position deviations of inventory holders. Because the fields of view of cameras are limited, in order to obtain sufficiently large deviation detection ranges, 9 two-dimensional codes are affixed in this embodiment, if the ranges are still not large enough, more two-dimensional codes can be affixed. In an embodiment, the bottom of inventory holders are full of two-dimensional codes; cameras only need to detect any one two-dimensional code to work out the position deviations of inventory holders.

The foregoing descriptions are not intended to limit the invention; any subtle modifications, equivalent replacements and improvements of the above embodiments according to the technical substance of the present invention are contained in the protection scope of the technical solution of the present invention.

1. A method for detecting position deviations of inventory holders based on feature information graphs, wherein the method comprises the following steps:
Step 1. Mount upward-looking cameras on robots; let the optical axes of the upward-looking cameras face upward;
Step 2. Calibrate the mapping relationship between the pixel coordinate system of the cameras and robot coordinate system;
Step 3. Dispose graphs having feature information on the bottom of the inventory holders, and measure coordinates of the feature points of the graphs under the coordinate system of inventory holders;
Step 4. After the robots lift the inventory holders, the upward-looking cameras scan the graphs, and obtain the pixel coordinates of the feature points of the graphs;
Step 5. Via the mapping relationship in Step 2, calculate and find out the coordinates mapped into the robot coordinate system by the pixel coordinates of the feature points of the graphs;
Step 6. Calculate the position deviations of the inventory holders relative to the robots, by Euclidean space coordinate transformation and least square method, according to the coordinates under the coordinate system of inventory holders and the coordinates under the robot coordinate system, of a plurality of the feature points of the graphs.

2. The method for detecting position deviations of inventory holders based on feature information graphs according to claim 1, wherein in Step 2, the mapping relationship refers to homography matrix H of the camera, and the mathematical meaning of homography matrix H is:
$$\begin{matrix}[ \begin{matrix}{x}^{′} \\ {y}^{′} \\ {z}^{′}\end{matrix} ] = H * [ \begin{matrix}u \\ v \\ 1\end{matrix} ] & ( Formula 1 ) \\ [ \begin{matrix}x \\ y\end{matrix} ] = [ \begin{matrix}{x}^{′} / {z}^{′} \\ {y}^{′} / {z}^{′}\end{matrix} ] & ( Formula 2 )\end{matrix}$$
wherein, select the plane where the bottom of inventory holders are located after the robots lift the inventory holders as a reference plane,
$$[ \begin{matrix}u \\ v\end{matrix} ]$$
are pixel coordinates on the camera's imaging plane of a certain point on the reference plane,
$$[ \begin{matrix}x \\ y\end{matrix} ]$$
are coordinates under the robot coordinate system of a certain point on the reference plane;
$$[ \begin{matrix}{x}^{′} \\ {y}^{′} \\ {z}^{′}\end{matrix} ]$$
are homogeneous coordinates;
the calibrating method of H is: obtain pixel coordinates on the camera's imaging plane and coordinates under the robot coordinate system of more than four points on the reference plane, then invoke the homography matrix calculation function in the open source visual sense library opencv to get H.

3. The method for detecting position deviations of inventory holders based on feature information graphs according to claim 1, wherein in Step 6, the position deviations of inventory holders relative to robots can be calculated and obtained by the following formula:
$$[ \begin{matrix}1 & 0 & {x}_{h} & - {y}_{h} \\ 0 & 1 & {y}_{h} & {x}_{h}\end{matrix} ] * [ \begin{matrix}{x}_{1} \\ {x}_{2} \\ {x}_{3} \\ {x}_{4}\end{matrix} ] = [ \begin{matrix}{x}_{r} \\ {y}_{r}\end{matrix} ] \qquad ( Formula 5 )$$
substitute the coordinates under the coordinate system of the inventory holders and the coordinates under the robot coordinate system of a plurality of feature points that are detected into formula 3, calculate x₁, x₂, x₃, x₄ by linear least square method, then normalize x₃, x₄, find out d θ according to reverse triangle after normalization, thereby
$$[ \begin{matrix}dx \\ dy \\ d θ\end{matrix} ]$$
is obtained;
in the formula, x₁=dx, x₂=dy, x₃=cos d θ, x₄=sin d θ,
$$[ \begin{matrix}{x}_{h} \\ {y}_{h}\end{matrix} ]$$
are coordinates under the coordinate system of inventory holders of the feature points,
$$[ \begin{matrix}{x}_{r} \\ {y}_{r}\end{matrix} ]$$
are coordinates under the robot coordinate system of the feature points,
$$[ \begin{matrix}dx \\ dy \\ d θ\end{matrix} ]$$
are position deviations of inventory holders relative to robots.

4. A system for detecting position deviations of inventory holders based on feature information graphs, wherein the system comprises robots, upward-looking cameras mounted thereon, inventory holders as well as graphs with feature information disposed on the bottom of the inventory holders; the graphs with feature information including two-dimensional codes, with four angular points of the two-dimensional codes serving as feature points of the graphs.

5. The detection system according to claim 4, wherein the number of two-dimensional codes is 9.

6. The detection system according to claim 4, wherein the bottom of the inventory holders are full of two-dimensional codes.

7. The detection system according to claim 4, wherein the bottom of the inventory holders are affixed with arbitrary number of two-dimensional codes.
